(19) United States
(12) Patent Application Publication
(10) Pub. No.: US 2025/0024424 A1
(43) Pub. Date: Jan. 16, 2025

(54) Communication Method and Apparatus

(71) Applicant: Huawei Technologies Co., Ltd., Shenzhen (CN)

(72) Inventors: Peng Liu, Shenzhen (CN); Ziyang Guo, Shenzhen (CN); Yuchen Guo, Shenzhen (CN); Yunbo Li, Shenzhen (CN); Li Sun, Shenzhen (CN)

(21) Appl. No.: 18/898,880

(22) Filed: Sep. 27, 2024

Related U.S. Application Data
(63) Continuation of application No. PCT/CN2023/084407, filed on Mar. 28, 2023.

(30) Foreign Application Priority Data
Mar. 30, 2022 (CN) 202210334540.8
Sep. 6, 2022 (CN) 202211095647.8
Sep. 9, 2022 (CN) 202211105324.2

(51) Int. Cl. H04W 64/00; H04L 1/1607; H04L 5/00; H04W 28/06

(52) U.S. Cl. CPC H04W 64/003; H04L 1/1607; H04L 5/0048; H04W 28/06

(57) ABSTRACT

A communication method includes determining a ranging signal, sending an n^{th} fragment of N fragments of the ranging signal in a first time unit, and sending an (n+1)^{th} fragment in a second time unit. The first time unit is one of M time units included in an n^{th} time period, and the second time unit is one of M time units included in an (n+1)^{th} time period, where there is a preset interval between the n^{th} time period and the (n+1)^{th} time period, n is an integer greater than 0 and less than N, and both N and M are integers greater than 1.

### CROSS-REFERENCE TO RELATED APPLICATIONS

This is a continuation of International Patent Application No. PCT/CN2023/084407 filed on Mar. 28, 2023, which claims priority to Chinese Patent Application No. 202210334540.8 filed on Mar. 30, 2022, Chinese Patent Application No. 202211095647.8 filed on Sep. 6, 2022, and Chinese Patent Application No. 202211105324.2 filed on Sep. 9, 2022. All of the aforementioned patent applications are hereby incorporated by reference in their entireties.

### TECHNICAL FIELD

This disclosure relates to the field of communication technologies, and in particular, to a communication method and apparatus.

### BACKGROUND

An ultra-wideband (UWB) technology is widely used in a positioning system due to a wide bandwidth (for example, 500 megahertz (MHz) or even wider) and a capability of obtaining a higher resolution compared with other wireless technologies. To improve a link budget, a narrowband-assisted UWB segmented transmission technology is proposed currently. To be specific, a UWB transmission frame is divided into N fragments for transmission.

Interference exists when ranging links of a plurality of users in a network are used to perform ranging at the same time. For example, when fragments on two ranging links overlap in time domain, interference is caused. Therefore, multi-user interference in a UWB system is an urgent problem to be resolved.

### SUMMARY

This disclosure provides a communication method and apparatus, to resolve a problem of multi-user interference in a UWB system.

According to a first aspect, this disclosure provides a communication method, and the method is applicable to a ranging initiator. The method may be performed by the ranging initiator, or may be performed by a chip or a circuit. The method includes determining a ranging signal, sending an n^{th} fragment of N fragments of the ranging signal in a first time unit, and sending an (n+1)^{th} fragment of the N fragments of the ranging signal in a second time unit. The first time unit is one of M1 time units included in an n^{th} time period, and the second time unit is one of M2 time units included in an (n+1)^{th} time period, where a time interval between the n^{th} time period and the (n+1)^{th} time period is a preset interval, n is an integer greater than 0 and less than N, N is an integer greater than 1, M1 is an integer greater than 1, and M2 is an integer greater than 1.

In an embodiment of this disclosure, time hopping is performed on fragments in corresponding time periods, so that interference between a plurality of ranging channels can be reduced. In addition, there is a preset interval (for example, a test period) between two time periods, to ensure that the time interval is not less than the test period, thereby ensuring that a transmit power is not reduced and ensuring a ranging range.

In a possible design, M1 is the same as M2.

In a possible design, the method further includes determining the first time unit and the second time unit based on a first linear feedback shift register (LFSR) function. An initial value of the first LFSR function is related to a channel index corresponding to first information, and the first information is used to configure at least one of the following: a quantity N of fragments included in the measurement signal or duration of each fragment.

In the foregoing implementation, a time hopping location of the ranging signal is associated with a channel index corresponding to a poll, so that time hopping locations of different ranging links may be staggered. Therefore, ranging signals can be sent on the different ranging links at different time domain locations, thereby avoiding mutual interference and improving ranging accuracy.

In a possible design, the first LFSR function is f(x)=x⁹+x⁵+1. In the foregoing manner, minor changes are made to a protocol.

In a possible design, the first LFSR function is a characteristic polynomial of a first sequence with a length of M1, and a highest order of the characteristic polynomial is greater than 9. In the foregoing manner, a period of the first LFSR can be increased, so that more channels and more fragments can be supported.

In a possible design, determining the first time unit and the second time unit based on a first LFSR function includes initializing the first LFSR based on the initial value of the first LFSR function, generating N numerical values based on the first LFSR function, separately performing a modulo operation on the N numerical values based on N, to obtain a second sequence with a length of N, determining that the first time unit is an I^{th} time unit in the n^{th} time period, where I is an i^{th} element value in a third sequence, i is an n^{th} element value in the second sequence, the third sequence is {0, 1, 2, 3, . . . , M1−1, 0, 1, 2, 3, . . . , M1−1, . . . }, and a length of the third sequence is N, and determining that the second time unit is a J^{th} time unit in the (n+1)^{th} time period, where J is a j^{th} element value in the third sequence, and j is an (n+1)^{th} element value in the second sequence.

In the foregoing manner, ranging signals on different ranging links are staggered in time domain, so that mutual interference between the different ranging links can be reduced, and ranging accuracy can be improved.

In a possible design, the first LFSR function is f(x)=x¹⁵+x¹⁴+1. In the foregoing manner, minor changes are made to a protocol.

In a possible design, determining the first time unit and the second time unit based on a first LFSR function includes initializing the first LFSR function based on the initial value of the first LFSR function, generating a binary random sequence s_{(k+nK)} and a binary random sequence s_{(k+(n+1) K)} based on the first LFSR function, where k={0, 1, 2, . . . , K−1}, and K is greater than or equal to log₂ M1, determining that the first time unit is an hₙ^{th} time unit in the n^{th} time period, where hₙ satisfies the following formula: hₙ=2⁰s_{nK}+2¹s_{(1+nK)}+ . . . +2^{m-1}s_{(K-1+nK)}, and determining that the second time unit is an h₍ₙ₊₁₎^{th} time unit in the (n+1)^{th} time period, where h₍ₙ₊₁₎ satisfies the following formula: h₍ₙ₊₁₎=2⁰s_{(n+1)K}+2¹s_{(1+(n+1)K)}+ . . . +2^{m-1}s_{(K-1+(n+1)K)}.

In the foregoing manner, ranging signals on different ranging links are staggered in time domain, so that mutual interference between the different ranging links can be reduced, and ranging accuracy can be improved.

In a possible design, that an initial value of the first LFSR function is related to a frequency domain location of first information includes the initial value of the first LFSR function is W times the channel index corresponding to the first information, where W is an integer greater than 0.

Because a poll may be transmitted through frequency hopping, channel indexes corresponding to polls of different ranging links are different. In the foregoing implementation, the time hopping location of the ranging signal is associated with the channel index corresponding to the poll, so that time hopping locations of different ranging links may be staggered. Therefore, the ranging signal can be sent on the different ranging links at different time domain locations, thereby avoiding mutual interference and improving ranging accuracy.

In a possible design, that an initial value of the first LFSR function is related to a frequency domain location of first information includes having a correspondence between the initial value of the first LFSR function and the channel index corresponding to the poll.

Because a poll may be transmitted through frequency hopping, channel indexes corresponding to polls of different ranging links are different. In the foregoing implementation, the time hopping location of the ranging signal is associated with the channel index corresponding to the poll, so that time hopping locations of different ranging links may be staggered. Therefore, the ranging signal can be sent on the different ranging links at different time domain locations, thereby avoiding mutual interference and improving ranging accuracy.

In a possible design, a product of W and a total quantity of channels is less than or equal to a period of the first LFSR function. In the foregoing manner, a possibility that ranging signals on different ranging links are repeated in time domain can be reduced, so that the ranging accuracy can be improved.

In a possible design, the method further includes determining the first time unit based on a second function, and determining the second time unit based on the second function, where the second function is used to determine a channel index corresponding to first information, and the first information is used to configure at least one of the following: a quantity of fragments included in the measurement signal or duration of each fragment.

In the foregoing manner, a same function is used for time hopping of the ranging signal and frequency hopping of the poll, so that time hopping locations of different ranging links may be staggered. Therefore, ranging signals can be sent on the different ranging links at different time domain locations, thereby avoiding mutual interference and improving ranging accuracy. In addition, in this manner, implementation complexity is low.

In a possible design, M1 is different from M2.

In a possible design, a location of the first time unit in the n^{th} time period and/or a location of the second time unit in the (n+1)^{th} time period are/is generated by using an encryption algorithm or a pseudo-random number generation algorithm.

In a possible design, the encryption algorithm may include one or more of the following: an Advanced Encryption Standard (AES) algorithm, a Zu Chongzhi (ZUC) algorithm, a snowflake (SNOW) algorithm, and the like.

In a possible design, the pseudo-random number generation algorithm may include one or more of the following: an LFSR, a linear congruential generator, a Mersenne Twister algorithm, a Well Equidistributed Long-period Linear (WELL) algorithm, and the like.

In a possible design, the location of the first time unit in the n^{th} time period and/or the location of the second time unit in the (n+1)^{th} time period are/is shared between a first device and a second device in an encrypted transmission manner.

In a possible design, a first key of the encryption algorithm or a first initial value of the pseudo-random number generation algorithm is shared between the first device and the second device. The first key or the first initial value is used to generate the location of the first time unit in the n^{th} time period and/or the location of the second time unit in the (n+1)^{th} time period.

In a possible design, a length of the n^{th} fragment is the same as a length of the (n+1)^{th} fragment, or a length of the n^{th} fragment is different from a length of the (n+1)^{th} fragment.

In a possible design, a length of the n^{th} time period and/or a length of the (n+1)^{th} time period are/is generated by using an encryption algorithm or a pseudo-random number generation algorithm.

In a possible design, a second key of the encryption algorithm or a second initial value of the pseudo-random number generation algorithm is shared between the first device and the second device. The second key or the second initial value is used to generate the length of the n^{th} time period and/or the length of the (n+1)^{th} time period.

In a possible design, the length of the n^{th} time period and/or the length of the (n+1)^{th} time period are/is shared between the first device and the second device in an encrypted transmission manner.

In a possible design, the length of the n^{th} fragment and/or the length of the (n+1)^{th} fragment are/is generated by using an encryption algorithm or a pseudo-random number generation algorithm.

In a possible design, a third key of the encryption algorithm or a third initial value of the pseudo-random number generation algorithm is shared between the first device and the second device. The third key or the third initial value is used to generate the length of the n^{th} fragment and/or the length of the (n+1)^{th} fragment.

In a possible design, the length of the n^{th} fragment and/or the length of the (n+1)^{th} fragment are/is shared between the first device and the second device in an encrypted transmission manner.

In a possible design, the method further includes sending second information, where the second information indicates the location of the first time unit in the n^{th} time period and the location of the second time unit in the (n+1)^{th} time period.

In a possible design, the second information may be shared between the first device and the second device in an encrypted transmission manner.

In a possible design, values of M1 and M2 may be shared between the first device and the second device in an encrypted manner.

In this implementation, a same function is used for time hopping of the fragments of the ranging signal and frequency hopping of the poll. Because counters of different channels are generally different, when polls of different ranging links are hopped to different channels, counters of subsequent time hopping channels are different. This ensures that when polls of a plurality of ranging links use different channels, a possibility of subsequent ranging signal interference is low, and the ranging accuracy is improved. In addition, in this manner, implementation complexity is low.

According to a second aspect, this disclosure provides a communication method, and the method is applicable to a ranging responder. The method may be performed by a ranging initiator, or may be performed by a chip or a circuit. The method includes receiving, in a first time unit, an n^{th} fragment of N fragments included in a ranging signal, and receiving, in a second time unit, an (n+1)^{th} fragment of the N fragments included in the ranging signal. The first time unit is one of M1 time units included in an n^{th} time period, and the second time unit is one of M2 time units included in an (n+1)^{th} time period, where a time interval between the n^{th} time period and the (n+1)^{th} time period is a preset interval, n is an integer greater than 0 and less than N, M1 is an integer greater than 1, and M2 is an integer greater than 1.

In this embodiment of this disclosure, time hopping is performed on fragments in corresponding time periods, so that interference between a plurality of ranging channels can be reduced. In addition, there is a preset interval (for example, a test period) between two time periods, to ensure that the time interval is not less than the test period, thereby ensuring that a transmit power is not reduced and ensuring a ranging range.

In a possible design, M1 is the same as M2.

In a possible design, the method further includes determining the first time unit and the second time unit based on a first LFSR function. An initial value of the first LFSR function is related to a channel index corresponding to first information, and the first information is used to configure at least one of the following a quantity N of fragments included in the measurement signal or duration of each fragment.

In the foregoing implementation, a time hopping location of the ranging signal is associated with a channel index corresponding to a poll, so that time hopping locations of different ranging links may be staggered. Therefore, ranging signals can be sent on the different ranging links at different time domain locations, thereby avoiding mutual interference and improving ranging accuracy.

In a possible design, the first LFSR function is f(x)=x⁹+x⁵+1. In the foregoing manner, minor changes are made to a protocol.

In a possible design, the first LFSR function is a characteristic polynomial of a first sequence with a length of M1, and a highest order of the characteristic polynomial is greater than 9. In the foregoing manner, a period of the first LFSR can be increased, so that more channels and more fragments can be supported.

In a possible design, determining the first time unit and the second time unit based on a first LFSR function includes initializing the first LFSR based on the initial value of the first LFSR function, generating N numerical values based on the first LFSR function, separately performing a modulo operation on the N numerical values based on N, to obtain a second sequence with a length of N, determining that the first time unit is an I^{th} time unit in the n^{th} time period, where I is an i^{th} element value in a third sequence, i is an n^{th} element value in the second sequence, the third sequence is {0, 1, 2, 3, . . . , M1−1, 0, 1, 2, 3, . . . , M1−1, . . . }, and a length of the third sequence is N, and determining that the second time unit is a J^{th} time unit in the (n+1)^{th} time period, where J is a j^{th} element value in the third sequence, and j is an (n+1)^{th} element value in the second sequence.

In the foregoing manner, ranging signals on different ranging links are staggered in time domain, so that mutual interference between the different ranging links can be reduced, and ranging accuracy can be improved.

In a possible design, the first LFSR function is f(x)=x¹⁵+x¹⁴+1. In the foregoing manner, minor changes are made to a protocol.

In a possible design, the determining the first time unit and the second time unit based on a first LFSR function includes initializing the first LFSR function based on the initial value of the first LFSR function, generating a binary random sequence s_{(k+nK)} and a binary random sequence s_{(k+(n+1) K)} based on the first LFSR function, where k={0, 1, 2, . . . , K−1}, and K is greater than or equal to log₂ M1, determining that the first time unit is an hₙ^{th} time unit in the n^{th} time period, where hₙ satisfies the following formula hₙ=2⁰s_{nK}+2¹s_{(1+nK)}+ . . . +2^{m-1}s_{(K-1+nK)}, and determining that the second time unit is an h₍ₙ₊₁₎^{th} time unit in the (n+1)^{th} time period, where h₍ₙ₊₁₎ satisfies the following formula h₍ₙ₊₁₎=2⁰s_{(n+1)K}+2¹s_{(1+(n+1)K)}+ . . . +2^{m-1}s_{(K-1+(n+1)K)}.

In the foregoing manner, ranging signals on different ranging links are staggered in time domain, so that mutual interference between the different ranging links can be reduced, and ranging accuracy can be improved.

In a possible design, that an initial value of the first LFSR function is related to a frequency domain location of first information includes the initial value of the first LFSR function is W times the channel index corresponding to the first information, where W is an integer greater than 0.

Because a poll may be transmitted through frequency hopping, channel indexes corresponding to polls of different ranging links are different. In the foregoing implementation, the time hopping location of the ranging signal is associated with the channel index corresponding to the poll, so that time hopping locations of different ranging links may be staggered. Therefore, the ranging signal can be sent on the different ranging links at different time domain locations, thereby avoiding mutual interference and improving ranging accuracy.

In a possible design, that an initial value of the first LFSR function is related to a frequency domain location of first information includes there is a correspondence between the initial value of the first LF SR function and the channel index corresponding to the poll.

Because a poll may be transmitted through frequency hopping, channel indexes corresponding to polls of different ranging links are different. In the foregoing implementation, the time hopping location of the ranging signal is associated with the channel index corresponding to the poll, so that time hopping locations of different ranging links may be staggered. Therefore, the ranging signal can be sent on the different ranging links at different time domain locations, thereby avoiding mutual interference and improving ranging accuracy.

In a possible design, a product of W and a total quantity of channels is less than or equal to a period of the first LFSR function. In the foregoing manner, a possibility that ranging signals on different ranging links are repeated in time domain can be reduced, so that the ranging accuracy can be improved.

In a possible design, the method further includes determining the first time unit based on a second function, and determining the second time unit based on the second function, where the second function is used to determine a channel index corresponding to first information, and the first information is used to configure at least one of the following: a quantity of fragments included in the measurement signal or duration of each fragment.

In this implementation, a same function is used for time hopping of the fragments of the ranging signal and frequency hopping of the poll. Because counters of different channels are generally different, when polls of different ranging links are hopped to different channels, counters of subsequent time hopping channels are different. This ensures that when polls of a plurality of ranging links use different channels, a possibility of subsequent ranging signal interference is low, and the ranging accuracy is improved. In addition, in this manner, implementation complexity is low.

In a possible design, M1 is different from M2.

In a possible design, a location of the first time unit in the n^{th} time period and/or a location of the second time unit in the (n+1)^{th} time period are/is generated by using an encryption algorithm or a pseudo-random number generation algorithm.

In a possible design, the encryption algorithm may include one or more of the following: an AES algorithm, a ZUC algorithm, a SNOW algorithm, and the like.

In a possible design, the pseudo-random number generation algorithm may include one or more of the following: an LFSR, a linear congruential generator, a Mersenne Twister algorithm, a WELL algorithm, and the like.

In a possible design, the location of the first time unit in the n^{th} time period and/or the location of the second time unit in the (n+1)^{th} time period are/is shared between a first device and a second device in an encrypted transmission manner.

In a possible design, a first key of the encryption algorithm or a first initial value of the pseudo-random number generation algorithm is shared between the first device and the second device. The first key or the first initial value is used to generate the location of the first time unit in the n^{th} time period and/or the location of the second time unit in the (n+1)^{th} time period.

In a possible design, a length of the n^{th} fragment is the same as a length of the (n+1)^{th} fragment, or a length of the n^{th} fragment is different from a length of the (n+1)^{th} fragment.

In a possible design, a length of the n^{th} time period and/or a length of the (n+1)^{th} time period are/is generated by using an encryption algorithm or a pseudo-random number generation algorithm.

In a possible design, a second key of the encryption algorithm or a second initial value of the pseudo-random number generation algorithm is shared between the first device and the second device. The second key or the second initial value is used to generate the length of the n^{th} time period and/or the length of the (n+1)^{th} time period.

In a possible design, the length of the n^{th} time period and/or the length of the (n+1)^{th} time period are/is shared between the first device and the second device in an encrypted transmission manner.

In a possible design, the length of the n^{th} fragment and/or the length of the (n+1)^{th} fragment are/is generated by using an encryption algorithm or a pseudo-random number generation algorithm.

In a possible design, a third key of the encryption algorithm or a third initial value of the pseudo-random number generation algorithm is shared between the first device and the second device. The third key or the third initial value is used to generate the length of the n^{th} fragment and/or the length of the (n+1)^{th} fragment.

In a possible design, the length of the n^{th} fragment and/or the length of the (n+1)^{th} fragment are/is shared between the first device and the second device in an encrypted transmission manner.

In a possible design, the method further includes receiving second information, where the second information indicates the location of the first time unit in the n^{th} time period and the location of the second time unit in the (n+1)^{th} time period. In this manner, a calculation amount of the ranging responder can be reduced, so that complexity and power consumption of the ranging responder can be reduced.

In a possible design, the second information may be shared between the first device and the second device in an encrypted transmission manner.

In a possible design, values of M1 and M2 may be shared between the first device and the second device in an encrypted manner.

According to a third aspect, this disclosure further provides a communication apparatus. The apparatus is a ranging initiator or a chip in the ranging initiator. The communication apparatus has a function of implementing any method provided in the first aspect. The communication apparatus may be implemented by hardware, or may be implemented by hardware executing corresponding software. The hardware or the software includes one or more units or modules corresponding to the foregoing function.

In a possible design, the communication apparatus includes a processor, and the processor is configured to support the communication apparatus in performing a corresponding function of a ranging initiator in the foregoing method. The communication apparatus may further include a memory. The memory may be coupled to the processor, and the memory stores program instructions and data that are necessary for the communication apparatus. Optionally, the communication apparatus further includes an interface circuit. The interface circuit is configured to support communication between the communication apparatus and a device such as a ranging responder.

In a possible design, the communication apparatus includes corresponding functional modules respectively configured to implement the steps in the foregoing method. The function may be implemented by hardware, or may be implemented by hardware executing corresponding software. The hardware or software includes one or more modules corresponding to the foregoing function.

In a possible design, a structure of the communication apparatus includes a processing unit (or a processing module) and a communication unit (or a communication module). These units may perform corresponding functions in the foregoing method examples. For details, refer to the descriptions in the method provided in the first aspect. Details are not described herein again.

According to a fourth aspect, this disclosure further provides a communication apparatus. The apparatus is a ranging responder or a chip in the ranging responder. The communication apparatus has a function of implementing any method provided in the second aspect. The communication apparatus may be implemented by hardware, or may be implemented by hardware executing corresponding software. The hardware or the software includes one or more units or modules corresponding to the foregoing function.

In a possible design, the communication apparatus includes a processor, and the processor is configured to support the communication apparatus in performing a corresponding function of a terminal device in the foregoing method. The communication apparatus may further include a memory. The memory may be coupled to the processor, and the memory stores program instructions and data that are necessary for the communication apparatus. Optionally, the communication apparatus further includes an interface circuit. The interface circuit is configured to support communication between the communication apparatus and a device such as a ranging initiator.

In a possible design, the communication apparatus includes corresponding functional modules respectively configured to implement the steps in the foregoing method. The function may be implemented by hardware, or may be implemented by hardware executing corresponding software. The hardware or software includes one or more modules corresponding to the foregoing function.

In a possible design, a structure of the communication apparatus includes a processing unit (or a processing module) and a communication unit (or a communication module). These units may perform corresponding functions in the foregoing method examples. For details, refer to the descriptions in the method provided in the second aspect. Details are not described herein again.

According to a fifth aspect, a communication apparatus is provided. The communication apparatus includes a processor and an interface circuit. The interface circuit is configured to receive a signal from a communication apparatus other than the communication apparatus and transmit the signal to the processor, or send a signal from the processor to a communication apparatus other than the communication apparatus. The processor is configured to implement the method in any one of the first aspect and the possible designs through a logic circuit or by executing code instructions.

According to a sixth aspect, a communication apparatus is provided. The communication apparatus includes a processor and an interface circuit. The interface circuit is configured to receive a signal from a communication apparatus other than the communication apparatus and transmit the signal to the processor, or send a signal from the processor to a communication apparatus other than the communication apparatus. The processor is configured to implement the method in any one of the second aspect and the possible designs through a logic circuit or by executing code instructions.

According to a seventh aspect, a computer-readable storage medium is provided. The computer-readable storage medium stores a computer program or instructions. When the computer program or the instructions are executed by a processor, the method in any one of the first aspect or the second aspect and the possible designs is implemented.

According to an eighth aspect, a computer program product storing instructions is provided. When the instructions are run by a processor, the method in any one of the first aspect or the second aspect and the possible designs is implemented.

According to a ninth aspect, a chip system is provided. The chip system includes a processor, and may further include a memory configured to implement the method in any one of the first aspect and the possible designs. The chip system may include a chip, or may include a chip and another discrete device.

According to a tenth aspect, a chip system is provided. The chip system includes a processor, and may further include a memory configured to implement the method in any one of the second aspect and the possible designs. The chip system may include a chip, or may include a chip and another discrete device.

According to an eleventh aspect, a ranging system is provided. The system includes the apparatus (for example, a ranging initiator) according to the first aspect and the apparatus (for example, a ranging responder) according to the second aspect.

### BRIEF DESCRIPTION OF DRAWINGS

FIG. 1 is a diagram of ranging according to an embodiment of this disclosure;

FIG. 2 is a diagram of a ranging signal divided into fragments for transmission according to an embodiment of this disclosure;

FIG. 3 is a diagram of ranging link interference according to an embodiment of this disclosure;

FIG. 4 is a diagram of an architecture of a communication system according to an embodiment of this disclosure;

FIG. 5 is a schematic flowchart of a communication method according to an embodiment of this disclosure;

FIG. 6 is a diagram of time hopping of a ranging signal according to an embodiment of this disclosure;

FIG. 7 is another diagram of time hopping of a ranging signal according to an embodiment of this disclosure;

FIG. 8 is another diagram of time hopping of a ranging signal according to an embodiment of this disclosure;

FIG. 9 is another diagram of time hopping of a ranging signal according to an embodiment of this disclosure;

FIG. 10 is a diagram of a structure of a communication apparatus according to an embodiment of this disclosure; and

FIG. 11 is a diagram of a structure of another communication apparatus according to an embodiment of this disclosure.

### DESCRIPTION OF EMBODIMENTS

To make objectives, technical solutions, and advantages of embodiments of this disclosure clearer, the following further describes embodiments of this disclosure in detail with reference to the accompanying drawings.

The following describes some terms in embodiments of this disclosure, to facilitate understanding of a person skilled in the art.

UWB technology:

Rapid popularization and development of mobile communication and Internet technologies drive people to have increasingly higher requirements for location services. For example, there are many application scenarios in aspects such as personnel positioning in a factory, goods positioning in a logistics warehouse, and intelligent sensing of a vehicle door lock. The UWB technology is widely used in a positioning system due to a wide bandwidth (for example, 500 MHz or even wider) and a capability of obtaining a higher resolution compared with other wireless technologies.

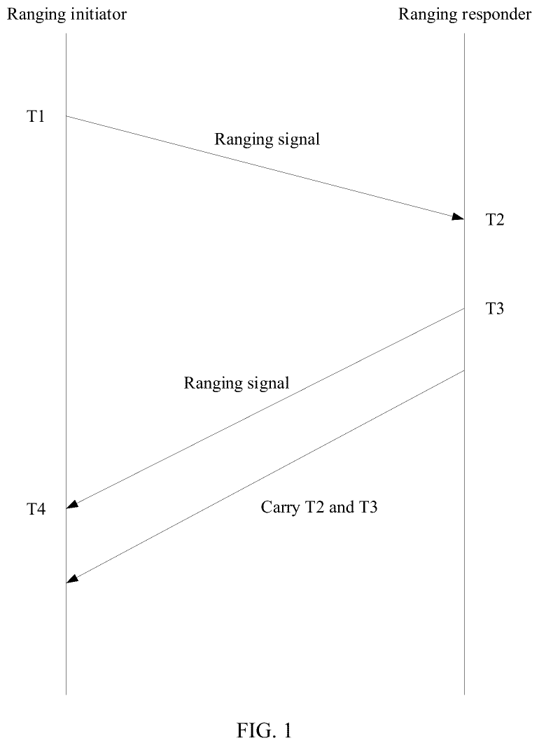

A basic ranging procedure is shown in FIG. 1. A ranging initiator sends a ranging signal at a moment T1, a ranging responder estimates T2 based on the ranging signal, the ranging responder sends a ranging response signal at a moment T3, and the ranging initiator estimates T4 based on the ranging response signal sent by the ranging responder. After sending the ranging response signal, the ranging responder sends a data frame, and the data frame carries T2 and/or T3. The ranging initiator and the ranging responder may estimate a distance d by using the following formula:

$$d = \frac{( {T}_{2} - {T}_{1} ) + ( {T}_{4} - {T}_{3} )}{2} * c ,$$

where c represents a propagation speed of an electromagnetic wave in a medium.

To prevent an ultra-wideband system from interfering with another system, transmit energy of the ultra-wideband system needs to be strictly controlled by regulations. It is stipulated by the regulations that radiant energy is limited to a preset energy (for example, 37 nanojoules (nJ)) within a test period (for example, 1 millisecond (ms)). To improve a link budget, a narrowband-assisted UWB segmented transmission technology is proposed. A whole UWB transmission frame is divided into N fragments, and a time interval between adjacent fragments is greater than the test period (for example, 1 ms). In this way, only a part of a signal is transmitted in the test period. Under the premise of ensuring that energy in the test period remains unchanged, transmit power is increased, the link budget is improved, and a ranging range is extended.

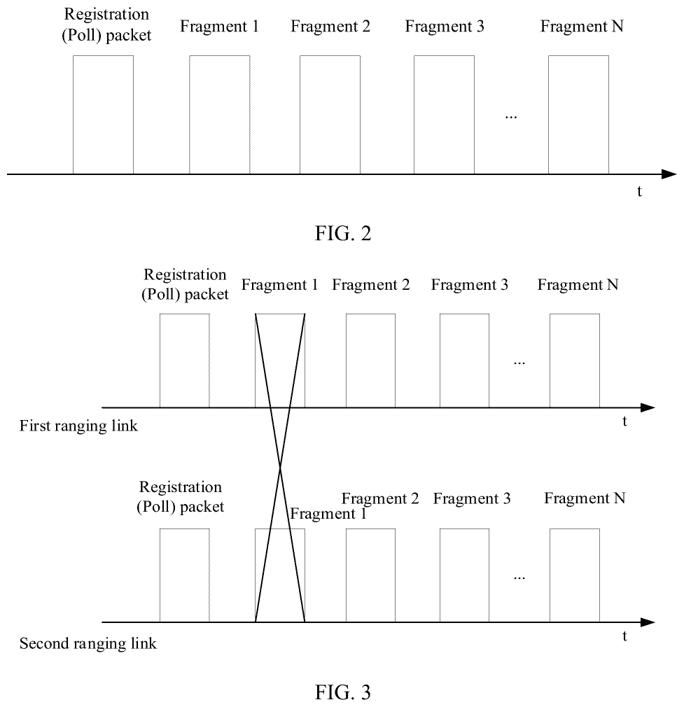

A specific manner is shown in FIG. 2. The ranging signal is divided into a plurality of fragments. Before the ranging signal is sent, synchronization is performed between the ranging initiator and the ranging responder. That is, the ranging initiator sends a registration (poll) packet, where the poll packet is used to configure a quantity N of fragments of a ranging signal 1 and duration of each fragment. The ranging responder sends a response (RES) packet after receiving the poll packet. Then, the ranging initiator sequentially sends the fragments of the ranging signal 1 to the ranging responder, where a time interval between a first Frag of the ranging signal 1 and the poll packet may be preset, or may be set in the poll packet, and a time interval between adjacent fragments is greater than a test period (for example, 1 ms). The fragments are generally sent at equal intervals. For example, an interval between two adjacent fragments is 1 ms.

In embodiments of this disclosure, “at least one” means one or more, and “a plurality of” means two or more. The term “and/or” describes an association relationship between associated objects, and indicates that three relationships may exist. For example, A and/or B may indicate the following cases: only A exists, both A and B exist, and only B exists, where A and B may be singular or plural. The character “/” generally indicates an “or” relationship between the associated objects. “At least one of the following items (pieces)” or a similar expression thereof means any combination of these items, including a single item (piece) or any combination of a plurality of items (pieces). For example, at least one item (piece) of a, b, or c may indicate a, b, c, a-b, a-c, b-c, or a-b-c, where a, b, and c may be singular or plural.

In addition, unless otherwise stated, ordinal numbers such as “first” and “second” in embodiments of this disclosure are used to distinguish between a plurality of objects, but are not intended to limit sizes, content, an order, a time sequence, priorities, importance, or the like of the plurality of objects. For example, a first fragment and a second fragment are merely used to distinguish between different fragments, but do not indicate different locations, priorities, importance, or the like of the two fragments.

The foregoing describes some terms in embodiments of this disclosure. The following describes technical features in embodiments of this disclosure.

Interference may exist when ranging links of a plurality of users in a network are used to perform ranging at the same time. For example, when fragments on two ranging links overlap in time domain, interference is caused. For example, when poll packets of ranging links of two users overlap in time domain and frequency domain, the poll packets of the ranging links of the two users interfere with each other. To resolve this problem, frequency hopping may be performed on synchronization signals (that is, poll packets and RES packets) of ranging links, to avoid mutual interference. However, because a frequency band for sending a ranging signal is fixed, and fragments are sent at equal intervals, ranging signals on different ranging links may overlap in time domain, causing mutual interference. For example, as shown in FIG. 3, a first fragment of a ranging link 1 and a first fragment of a ranging link 2 overlap in time domain. Therefore, the first fragment of the ranging link 1 and the first fragment of the ranging link 2 interfere with each other.

For this problem, a possible solution is that a time interval between two adjacent fragments is random. However, if the time interval between two adjacent fragments is completely random, it cannot be ensured that the time interval is not less than the test period. If the time interval between two adjacent fragments is less than the test period, the transmit power needs to be reduced, resulting in a reduced ranging range. In addition, link interference may still exist when the time interval between two adjacent fragments is random. Therefore, multi-user interference in the UWB system is an urgent problem to be resolved.

In view of this, embodiments of this disclosure provide a communication method and apparatus, to resolve a problem of multi-user interference in a UWB system. The method and the apparatus are based on a same concept. The method and the apparatus have a similar problem-resolving principle. Therefore, for implementations of the apparatus and the method, refer to each other. No repeated description is provided.

The communication method provided in this disclosure may be applied to various communication systems, for example, an Internet of things (IoT), a narrow band IoT (NB-IoT), LTE, a 5th generation (5G) communication system, a hybrid architecture of Long-Term Evolution (LTE) and 5G, a 5G New Radio (NR) system, a sixth generation (6G) communication system, a new communication system emerging in future communication development, or the like.

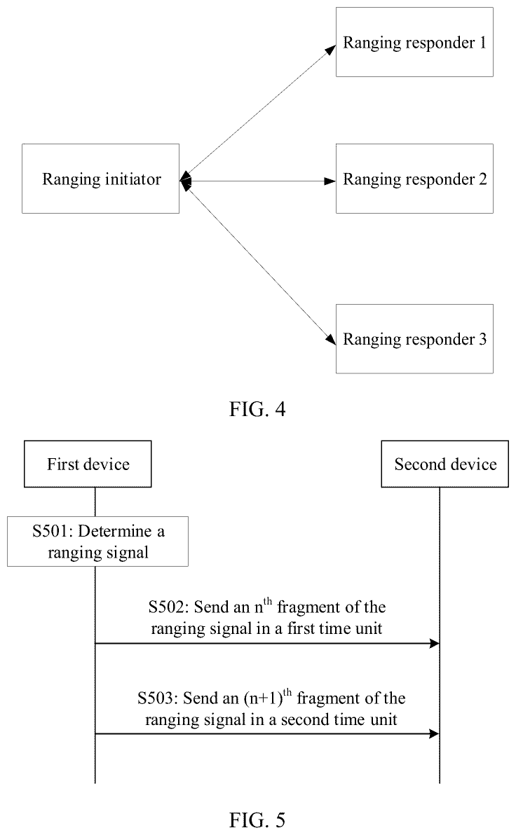

FIG. 4 shows an architecture of a communication system according to an embodiment of this disclosure. The architecture of the communication system may include at least one ranging initiator and at least one ranging responder. For example, one ranging initiator and a plurality of ranging responders (such as a ranging responder 1, a ranging responder 2, and a ranging responder 3 in FIG. 4) are shown as an example in FIG. 4. The communication system shown in FIG. 4 may be applied to scenarios such as synchronization, ranging, and positioning.

Further, the ranging initiator sends a ranging signal to the ranging responder, and the ranging responder replies the ranging initiator with a ranging response signal, to enable the ranging initiator to determine a distance between the ranging initiator and the ranging responder, and the like. For example, the ranging initiator may be a network device, and the ranging responder may be a terminal device. Alternatively, both the ranging initiator and the ranging responder may be terminal devices. Alternatively, the ranging initiator and the ranging responder may be other devices that can implement ranging, for example, a UWB device. This is not limited in this disclosure.

The network device may be a device having a wireless transceiver function or a chip that may be disposed in the network device. The network device includes but is not limited to a base station (generation NodeB (gNB)), a radio network controller (RNC), a NodeB (NB), a base station controller (BSC), a base transceiver station (BTS), a home base station (for example, a home evolved NodeB or a home NodeB (HNB)), a baseband unit (BBU), an access point (AP) in a WI-FI system, a wireless relay node, a wireless backhaul node, a transmission point (transmission and reception point (TRP) or transmission point (TP)), and the like. Alternatively, the network device may be a network node, for example, a baseband unit (BBU), or a distributed unit (DU), that constitutes a gNB or a transmission point.

The terminal device may also be referred to as user equipment (UE), an access terminal, a subscriber unit, a subscriber station, a mobile station, a remote station, a remote terminal, a mobile device, a user terminal, a terminal, a wireless communication device, a user agent, or a user apparatus. The terminal device in this embodiment of this disclosure may be a mobile phone, a tablet computer (such as an IPAD), a computer having a wireless transceiver function, a virtual reality (VR) terminal device, an augmented reality (AR) terminal device, a wireless terminal in industrial control, a wireless terminal in self driving, a wireless terminal in remote medical, a wireless terminal in a smart grid, a wireless terminal in transportation safety, a wireless terminal in a smart city, a smart wearable device (smart glasses, a smartwatch, a smart headset, or the like), a wireless terminal in a smart home, or the like. Alternatively, the terminal device may be a chip, a chip module (or a chip system), or the like that may be disposed in the foregoing device. In this disclosure, a terminal device having a wireless transceiver function and a chip that may be disposed in the terminal device are collectively referred to as a terminal device.

It should be noted that a quantity of devices in the communication system shown in FIG. 1 is merely an example, and is not intended to limit this disclosure.

A network architecture and a service scenario that are described in embodiments of this disclosure are intended to describe the technical solutions in embodiments of this disclosure more clearly, and do not constitute a limitation on the technical solutions provided in embodiments of this disclosure. A person of ordinary skill in the art may know that, with evolution of the network architecture and emergence of a new service scenario, the technical solutions provided in embodiments of this disclosure are also applicable to a similar technical problem.

It should be noted that in the following descriptions, an example in which a first device is a ranging initiator and a second device is a ranging responder is used for description. In the following descriptions, only the first device and the second device are used as execution bodies for description. Optionally, an operation of the first device may alternatively be performed by a processor, a chip, or a functional module in the first device, and an operation of the second device may alternatively be performed by a processor, a chip, or a functional module in the second device. This is not limited in this disclosure.

FIG. 5 is a schematic flowchart of a communication method according to this disclosure. The method includes the following steps.

S501: A first device determines a ranging signal.

The ranging signal includes N fragments, where N is an integer greater than 1.

S502: The first device sends an n^{th} fragment of the ranging signal in a first time unit. Correspondingly, a second device receives the n^{th} fragment of the ranging signal in the first time unit.

S503: The first device sends an (n+1)^{th} fragment of the ranging signal in a second time unit. Correspondingly, the second device receives the (n+1)^{th} fragment of the ranging signal in the second time unit.

The first time unit is one of M1 time units included in an n^{th} time period, where n is an integer greater than 0 and less than N, and M1 is an integer greater than 1. The second time unit is one of M2 time units included in an (n+1)^{th} time period, where M2 is an integer greater than 1. A time interval between the n^{th} time period and the (n+1)^{th} time period is a preset interval.

It should be noted that a length relationship between any two time periods is not limited in this disclosure, and lengths of any two time periods may be the same or may be different. For example, lengths of the n^{th} time period and the (n+1)^{th} time period may be the same (in other words, M1 is equal to M2), or may be different (in other words, M1 is not equal to M2). Optionally, values of M1 and M2 may be shared between the first device and the second device in an encrypted manner.

Optionally, if lengths of any two time periods may be different, the length of the n^{th} time period and/or the length of the (n+1)^{th} time period may be configured by using first information described below. The first information is used to configure at least one of the following a quantity N of fragments included in the measurement signal. In an example for description, the first information may be a poll.

Further, the first information may configure the length of the n^{th} time period and/or the length of the (n+1)^{th} time period within a preset range. A start point of the preset range is a minimum length supported by each time period, and an end point of the preset range is a maximum length supported by each time period. For example, the first information may configure the length of the n^{th} time period as Ln, where Ln belongs to (0, X). That is, 0≤Ln≤X.

In this disclosure, lengths of any two fragments may be the same or may be different. For example, a length of each fragment may be configured by using the first information described below, or may be randomly generated by the first device.

In a possible implementation, the first information may configure at least one of the following in an encrypted manner a length of each fragment, a length of each time period, or a time hopping location. The time hopping location may include a location of the first time unit in the n^{th} time period, a location of the second time unit in the (n+1)^{th} time period, and the like.

Further, the length of each fragment, the length of each time period, and the time hopping location may be generated by using an encryption algorithm or a pseudo-random number generation algorithm.

For example, the encryption algorithm may include at least one of the following: an AES, a ZUC algorithm, a SNOW algorithm, or the like.

The pseudo-random number generation algorithm may include at least one of the following: an LFSR, a linear congruential generator, a Mersenne Twister algorithm, a WELL algorithm, or the like.

For the time hopping location, in a possible implementation, the time hopping location, for example, the location of the first time unit in the n^{th} time period and/or the location of the second time unit in the (n+1)^{th} time period, may be shared between the first device and the second device in an encrypted transmission manner.

For the time hopping location, in another possible implementation, a first key of the encryption algorithm or a first initial value of the pseudo-random number generation algorithm is shared between the first device and the second device. The first key or the first initial value is used to generate the time hopping location, for example, generate the location of the first time unit in the n^{th} time period, the location of the second time unit in the (n+1)^{th} time period, and/or the like.

For the length of each time period, in a possible implementation, the length of each time period, for example, the length of the n^{th} time period and/or the length of the (n+1)^{th} time period, may be shared between the first device and the second device in an encrypted transmission manner.

For the length of each time period, in another possible implementation, a second key of the encryption algorithm or a second initial value of the pseudo-random number generation algorithm is shared between the first device and the second device. The second key or the second initial value is used to generate the length of each time period, for example, generate the length of the n^{th} time period, the length of the (n+1)^{th} time period, and/or the like.

For the length of each fragment, in a possible implementation, the length of each fragment, for example, the length of the n^{th} fragment and/or the length of the (n+1)^{th} fragment, may be shared between the first device and the second device in an encrypted transmission manner.

For the length of each fragment, in another possible implementation, a third key of the encryption algorithm or a third initial value of the pseudo-random number generation algorithm is shared between the first device and the second device. The third key or the third initial value is used to generate the length of each fragment, for example, generate the length of the n^{th} fragment, the length of the (n+1)^{th} fragment, and/or the like.

It should be noted that any two of the first key, the second key, and the third key may be the same or may be different. This is not limited herein.

Any two of the first initial value, the second initial value, and the third initial value may be the same or may be different. This is not limited herein.

For ease of understanding of the solution, an example in which any two time periods have a same length and both include M time units is used below for description.

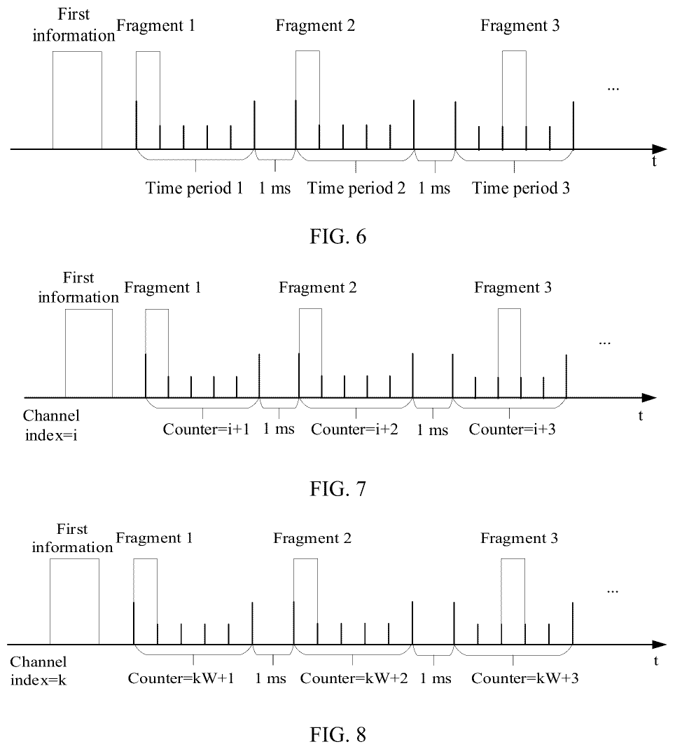

In an example for description, each fragment of the ranging signal corresponds to one time period, and there is a preset interval, for example, 1 ms, between time periods corresponding to any two adjacent fragments. The time period corresponding to each fragment includes M time units. For example, the time period corresponding to each fragment includes M timeslots, and each fragment of the ranging signal may be sent in one time unit of the corresponding time period. As shown in FIG. 6, for example, M is equal to 5, in other words, each time period includes five timeslots. A fragment 1 of the ranging signal is sent in one timeslot of a time period 1, a fragment 2 is sent in one timeslot of a time period 2, and an interval between the time period 1 and the time period 2 is 1 ms. A fragment 3 is sent in one timeslot of a corresponding time period 3, and an interval between the time period 2 and the time period 3 is 1 ms. The rest may be deduced by analogy.

In this embodiment of this disclosure, time hopping is performed on fragments in corresponding time periods, so that interference between a plurality of ranging channels can be reduced. In addition, there is a preset interval (for example, a test period) between two time periods, to ensure that the time interval is not less than the test period, thereby ensuring that a transmit power is not reduced and ensuring a ranging range.

The following describes manners in which the first device and the second device determine the location of the first time unit in the n^{th} time period and the location of the second time unit in the (n+1)^{th} time period.

It should be noted that a manner in which the second device determines the location of the first time unit in the n^{th} time period and the location of the second time unit in the (n+1)^{th} time period may be the same as a manner in which the first device determines the location of the first time unit in the n^{th} time period and the location of the second time unit in the (n+1)^{th} time period. Alternatively, the first device may indicate the location of the first time unit in the n^{th} time period and the location of the second time unit in the (n+1)^{th} time period by using second information. Correspondingly, the second device may determine the location of the first time unit in the n^{th} time period and the location of the second time unit in the (n+1)^{th} time period based on the second information. Optionally, the second information may be carried in the poll and sent to the second device, or the second information may be sent before or after the poll.

Optionally, the second information may be shared between the first device and the second device in an encrypted transmission manner.

In a possible implementation, the first device may determine the location of the first time unit in the n^{th} time period and the location of the second time unit in the (n+1)^{th} time period in the following manner determining the first time unit and the second time unit based on a first LFSR function, where an initial value of the first LFSR function is related to a channel index corresponding to the first information. It is assumed that the first information is a poll, the location of the first time unit in the n^{th} time period and the location of the second time unit in the (n+1)^{th} time period may be related to a channel index corresponding to the poll. That is, a time hopping location of the ranging signal is determined based on the channel index corresponding to the poll.

For ease of understanding, the following uses an example in which the first information is a poll for description.

Because a poll may be transmitted through frequency hopping, channel indexes corresponding to polls of different ranging links are different. In the foregoing implementation, the time hopping location of the ranging signal is associated with the channel index corresponding to the poll, so that time hopping locations of different ranging links may be staggered. Therefore, the ranging signal can be sent on the different ranging links at different time domain locations, thereby avoiding mutual interference and improving ranging accuracy.

Further, the initial value of the first LFSR function is related to the channel index corresponding to the poll. The initial value of the first LFSR function may be directly or indirectly related to the channel index corresponding to the poll.

For example, that the initial value of the first LFSR function is directly related to the channel index corresponding to the poll may be understood as that the initial value of the first LFSR function is W times the channel index corresponding to the poll, where W is an integer greater than 0.

In an example, the initial value of the first LFSR function may be the channel index corresponding to the poll. That is, W=1. In a specific example, the first LFSR function generally uses a counter as an input. It is assumed that the channel index corresponding to the poll is i, and an initial value of the counter is i. When a first fragment of the ranging signal is sent, counter=i+1, when a second fragment of the ranging signal is sent, counter=i+2, when a third fragment of the ranging signal is sent, counter=+3, and by analogy, when an N^{th} fragment of the ranging signal is sent, counter=+N, as shown in FIG. 7.

In another example, W may be equal to a value obtained by dividing a total quantity of channels used to transmit the poll by a total quantity of ranging links. For example, it is assumed that the total quantity of channels used to transmit the poll is 10, and the total quantity of ranging links is 5, W may be 2. Optionally, a product of W and the total quantity of channels is less than or equal to a period of the first LFSR function. For example, the period of the first LFSR is 512, and if the total quantity of channels is 25, a maximum value of W may be 20. In a specific example, the first LFSR function generally uses a counter as an input. It is assumed that the channel index corresponding to the poll is k, and an initial value of the counter is kW. When a first fragment of the ranging signal is sent, counter=kW+1, when a second fragment of the ranging signal is sent, counter=kW+2, when a third fragment of the ranging signal is sent, counter=kW+3, and by analogy, when an N^{th} fragment of the ranging signal is sent, counter=kW+N, as shown in FIG. 8.

For another example, that the initial value of the first LFSR function is directly related to the channel index corresponding to the poll may alternatively be understood as that the initial value of the first LFSR function is the channel index corresponding to the poll minus Y1, or the initial value of the first LFSR function is the channel index corresponding to the poll plus Y2, or the initial value of the first LFSR function is X times the channel index corresponding to the poll plus or minus a value, or the like.

For example, that the initial value of the first LFSR function is indirectly related to the channel index corresponding to the poll is understood as that there is a one-to-one correspondence between the initial value of the first LFSR function and the channel index corresponding to the poll.

The foregoing understanding is merely an example for description, and a manner in which the initial value of the first LFSR function is related to the channel index corresponding to the poll is not limited herein.

The following describes the first LFSR function by using examples.

Example 1: The first LFSR function may be f(x)=x⁹+x⁵+1.

Example 2: The first LFSR function may alternatively be a characteristic polynomial of the first sequence with a length of M, and a highest order of the characteristic polynomial is greater than 9. For example, the first LFSR function is x¹⁰+x⁷+1, or the first LFSR function is a characteristic polynomial with another order. This is merely an example for description herein, and the first LFSR function is not limited. In Example 2, the period of the first LFSR can be increased, so that more channels and more fragments can be supported.

Example 3: The first LFSR function may be f(x)=x¹⁵+x¹⁴+1.

The following describes two implementations of determining the location of the first time unit in the n^{th} time period and the location of the second time unit in the (n+1)^{th} time period by using examples.

In an implementation 1, the location of the first time unit in the n^{th} time period and the location of the second time unit in the (n+1)^{th} time period may be determined by using the following A1 to A4.

A1: The first device initializes the first LFSR based on the initial value of the first LFSR function.

The initial value of the first LFSR function is related to the channel index corresponding to the poll. For a specific related manner, refer to the foregoing related descriptions. Details are not described herein again.

A2: The first device generates N numerical values based on the first LFSR function.

In an implementation, the first device may randomly generate N numerical values in 1 to Q based on the first LFSR function. Q is the period of the first LFSR function.

A3: The first device separately performs a modulo operation on the N numerical values based on N, to obtain a second sequence with a length of N.

A4: The first device may determine that the first time unit is an I^{th} time unit in the n^{th} time period, and the second time unit is a J^{th} time unit in the (n+1)^{th} time period. I is an i^{th} element value in a third sequence, i is an n^{th} element value in the second sequence, J is a j^{th} element value in the third sequence, and j is an (n+1)^{th} element value in the second sequence. The third sequence is a set of 0 to M−1 in ascending order and has a length of N. That is, the third sequence is {0, 1, 2, 3, . . . , M−1, 0, 1, 2, 3 . . . , M−1, . . . }. For example, when M is equal to 4, and N is equal to 10, the third sequence is {0, 1, 2, 3, 0, 1, 2, 3, 0, 1}.

In an implementation, the first device may exchange TimeSlot[i] and TimeSlot[Shuffle[i]]. Shuffle[i] is the i^{th} element value in the second sequence, and TimeSlot[i] is an i^{th} element value in the third sequence.

In this case, the first device may determine that the first time unit is TimeSlot[Shuffle[n]] in the n^{th} time period, and the second time unit is TimeSlot[Shuffle[n+1]] in the n^{th} time period.

Optionally, the implementation 1 may be implemented with reference to Example 1 or Example 2.

In an implementation 2, the location of the first time unit in the n^{th} time period and the location of the second time unit in the (n+1)^{th} time period may be determined by using the following B1 to B4.

B1: The first device initializes the first LFSR function based on the initial value of the first LFSR function.

The initial value of the first LFSR function is related to the channel index corresponding to the poll. For a specific related manner, refer to the foregoing related descriptions. Details are not described herein again.

B2: The first device generates a binary random sequence s_{(k+nK)} and a binary random sequence s_{(k+(+1)K)} based on the first LFSR function, where k={0, 1, 2, . . . , K−1}, and K is greater than or equal to log₂ M.

B3: The first device may determine the location of the first time unit in the n^{th} time period and the location of the second time unit in the (n+1)^{th} time period based on hₜ=2⁰s_{tK}+2¹s_{(1+tK)}+ . . . +2^{m-1}s_{(K-1+tK)}, where t={1, 2, 3, . . . , N}.

For example, the first device may determine, based on 2⁰s_{tK}+2¹s_{(1+tK)}+ . . . +2^{m-1}s_{(K-1+tK)}, that the first time unit is a (2⁰s_{nK}+2¹s_{(1+nK)}+ . . . +2^{m-1}s_{(K-1+nK)})^{th} time unit in the n^{th} time period, and that the second time unit is a (2⁰s_{(n+1)K}+2¹s_{(1+(n+1)K)}+ . . . +2^{m-1}s_{(K-1+(n+1)K)})^{th} time unit in the (n+1)^{th} time period.

Optionally, the implementation 1 may be implemented with reference to Example 3.

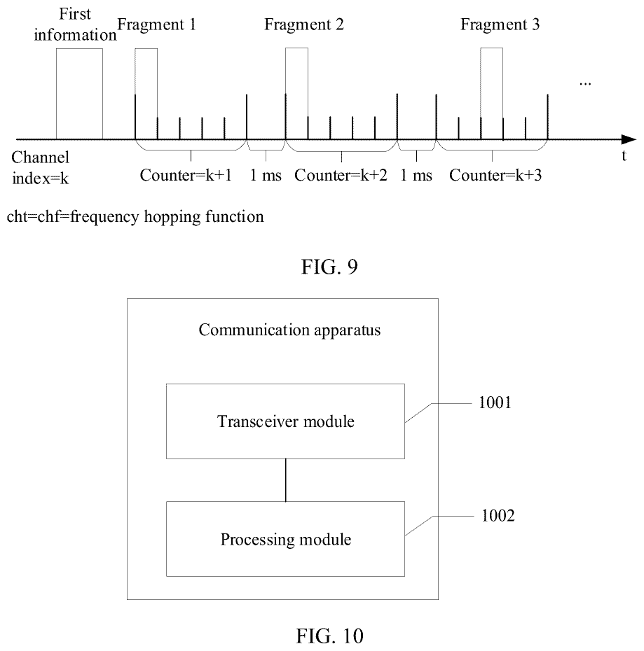

In another possible implementation, the first device may alternatively determine the location of the first time unit in the n^{th} time period and the location of the second time unit in the (n+1)^{th} time period in the following manner: determining the first time unit and the second time unit based on a second function, where the second function is used to determine the channel index corresponding to the poll. For example, cht represents a time hopping channel, that is, any value in 1 to M, and chf represents a frequency hopping channel, that is, the channel index of the poll. hop(*) represents a frequency hopping function (namely, the second function), and cht=chf=hop(counter), as shown in FIG. 9.

In this implementation, a same function is used for time hopping of the fragments of the ranging signal and frequency hopping of the poll. Because counters of different channels are generally different, when polls of different ranging links are hopped to different channels, counters of subsequent time hopping channels are different. This ensures that when polls of a plurality of ranging links use different channels, a possibility of subsequent ranging signal interference is low, and the ranging accuracy is improved.

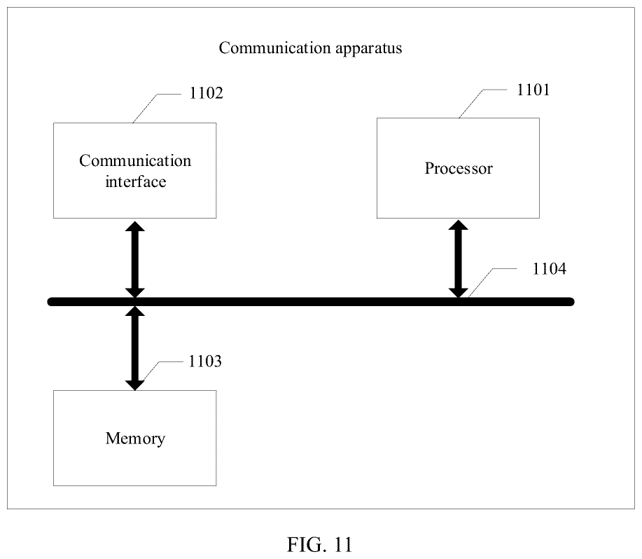

Based on a same concept as the method embodiment, an embodiment of this disclosure provides a communication apparatus. A structure of the communication apparatus may be shown in FIG. 10. The communication apparatus includes a transceiver module 1001 and a processing module 1002.

In an implementation, the communication apparatus may be further configured to implement the method performed by the first device in the embodiment shown in FIG. 5. The apparatus may be the first device, or may be a chip or a chipset in the first device, or a part that is of the chip and that is configured to perform a function of a related method. The processing module 1002 is configured to determine a ranging signal, where the ranging signal includes N fragments, and N is an integer greater than 1. The transceiver module 1001 is configured to send an n^{th} fragment of the ranging signal in a first time unit, where the first time unit is one of M1 time units included in an n^{th} time period, n is an integer greater than 0 and less than N, and M1 is an integer greater than 1, and send an (n+1)^{th} fragment of the ranging signal in a second time unit, where the second time unit is one of M2 time units included in an (n+1)^{th} time period, a time interval between the n^{th} time period and the (n+1)^{th} time period is a preset interval, and M2 is an integer greater than 1.

For example, M1 is the same as M2.

Optionally, the processing module 1002 is further configured to determine the first time unit and the second time unit based on a first LFSR function, where an initial value of the first LFSR function is related to a channel index corresponding to first information, and the first information is used to configure at least one of the following a quantity N of fragments included in the measurement signal or duration of each fragment.

For example, the first LFSR function is f(x)=x⁹+x⁵+1.

For example, the first LFSR function is a characteristic polynomial of a first sequence with a length of M1, and a highest order of the characteristic polynomial is greater than 9.

Optionally, when determining the first time unit and the second time unit based on the first LFSR function, the processing module 1002 is further configured to initialize the first LFSR based on the initial value of the first LFSR function, generate N numerical values based on the first LFSR function, separately perform a modulo operation on the N numerical values based on N, to obtain a second sequence with a length of N, determine that the first time unit is an I^{th} time unit in the n^{th} time period, where I is an i^{th} element value in a third sequence, i is an n^{th} element value in the second sequence, the third sequence is {0, 1, 2, 3, . . . , M1−1, 0, 1, 2, 3, . . . , M1−1, . . . } and a length of the third sequence is N, and determine that the second time unit is a J^{th} time unit in the (n+1)^{th} time period, where J is a j^{th} element value in the third sequence, and j is an (n+1)^{th} element value in the second sequence.

For example, the first LFSR function is f(x)=x¹⁵+x¹⁴+1.

Optionally, when determining the first time unit and the second time unit based on the first LFSR function, the processing module 1002 is further configured to initialize the first LFSR function based on the initial value of the first LFSR function, generate a binary random sequence s_{(k+nK)} and a binary random sequence s_{(k+(n+1) K)} based on the first LFSR function, where k={0, 1, 2, . . . , K−1}, and K is greater than or equal to log₂ M 1, determine that the first time unit is an hₙ^{th} time unit in the n^{th} time period, where hₙ satisfies the following formula hₙ=2⁰s_{nK}+2¹s_{(1+nK)}+ . . . +2^{m-1}s_{(K-1+nK)}, and determine that the second time unit is an h₍ₙ₊₁₎^{th} time unit in the (n+1)^{th} time period, where h₍ₙ₊₁₎ satisfies the following formula h₍ₙ₊₁₎=2⁰s_{(n+1)K}+2¹s_{(1+(n+1)K)}+ . . . +2^{m-1}s_{(K-1+(n+1)K)}.

For example, that an initial value of the first LFSR function is related to a frequency domain location of first information includes the initial value of the first LFSR function is W times the channel index corresponding to the first information, where W is an integer greater than 0.

Optionally, a product of W and a total quantity of channels is less than or equal to a period of the first LFSR function.

Optionally, the processing module 1002 is further configured to determine the first time unit based on a second function, and determine the second time unit based on the second function, where the second function is used to determine a channel index corresponding to first information, and the first information is used to configure at least one of the following: a quantity of fragments included in the measurement signal or duration of each fragment.

For example, M1 is different from M2.

Optionally, a length of the n^{th} time period and/or a length of the (n+1)^{th} time period may be generated by using an encryption algorithm or a pseudo-random number generation algorithm.

Optionally, a length of the n^{th} fragment and/or a length of the (n+1)^{th} fragment may be generated by using an encryption algorithm or a pseudo-random number generation algorithm.

Optionally, a location of the first time unit in the n^{th} time period and/or a location of the second time unit in the (n+1)^{th} time period may be generated by using an encryption algorithm or a pseudo-random number generation algorithm.

Optionally, the transceiver module 1001 is further configured to send second information, where the second information indicates the location of the first time unit in the n^{th} time period and the location of the second time unit in the (n+1)^{th} time period.

In another implementation, the communication apparatus may be configured to implement the method performed by the second device in the embodiment shown in FIG. 5. The apparatus may be the second device, or may be a chip or a chipset in the second device, or a part that is of the chip and that is configured to perform a function of a related method. The transceiver module 1001 is configured to receive a ranging signal. The processing module 1002 is configured to receive, in a first time unit by using the transceiver module 1001, an n^{th} fragment of N fragments included in the ranging signal, where the first time unit is one of M1 time units included in an n^{th} time period, n is an integer greater than 0 and less than N, and M1 is an integer greater than 1, and receive, in a second time unit by using the transceiver module 1001, an (n+1)^{th} fragment of the N fragments included in the ranging signal, where the second time unit is one of M2 time units included in an (n+1)^{th} time period, M2 is an integer greater than 1, and a time interval between the n^{th} time period and the (n+1)^{th} time period is a preset interval.

For example, M1 is the same as M2.

Optionally, the processing module 1002 is further configured to determine the first time unit and the second time unit based on a first LFSR function, where an initial value of the first LFSR function is related to a channel index corresponding to first information, and the first information is used to configure at least one of the following a quantity N of fragments included in the measurement signal or duration of each fragment.

For example, the first LFSR function is f(x)=x⁹+x⁵+1.

For example, the first LFSR function is a characteristic polynomial of a first sequence with a length of M1, and a highest order of the characteristic polynomial is greater than 9.

Optionally, when determining the first time unit and the second time unit based on the first LFSR function, the processing module 1002 is further configured to initialize the first LFSR based on the initial value of the first LFSR function, generate N numerical values based on the first LFSR function, separately perform a modulo operation on the N numerical values based on N, to obtain a second sequence with a length of N, determine that the first time unit is an I^{th} time unit in the n^{th} time period, where I is an i^{th} element value in a third sequence, i is an n^{th} element value in the second sequence, the third sequence is {0, 1, 2, 3, . . . , M1−1, 0, 1, 2, 3, . . . , M1−1, . . . } and a length of the third sequence is N, and determine that the second time unit is a J^{th} time unit in the (n+1)^{th} time period, where J is a j^{th} element value in the third sequence, and j is an (n+1)^{th} element value in the second sequence.

For example, the first LFSR function is f(x)=x¹⁵+x¹⁴+1.

Optionally, when determining the first time unit and the second time unit based on the first LFSR function, the processing module 1002 is further configured to initialize the first LFSR function based on the initial value of the first LFSR function, generate a binary random sequence s_{(k+nK)} and a binary random sequence s_{(k+(n+1) K)} based on the first LFSR function, where k={0, 1, 2, . . . , K−1}, and K is greater than or equal to log₂ M 1, determine that the first time unit is an h₁₁th time unit in the n^{th} time period, where h₁ satisfies the following formula hₙ=2⁰s_{nK}+2¹s_{(1+nK)}+ . . . +2^{m-1}s_{(K-1+nK)}, and determine that the second time unit is an h₍ₙ₊₁₎^{th} time unit in the (n+1)^{th} time period, where h₍ₙ₊₁₎ satisfies the following formula h₍ₙ₊₁₎=2⁰s_{(n+1)K}+2¹s_{(1+(n+1)K)}+ . . . +2^{m-1}s_{(K-1+(n+1)K)}.

For example, that an initial value of the first LFSR function is related to a frequency domain location of first information includes the initial value of the first LFSR function is W times the channel index corresponding to the first information, where W is an integer greater than 0.

Optionally, a product of W and a total quantity of channels is less than or equal to a period of the first LFSR function.

Optionally, the processing module 1002 is further configured to determine the first time unit based on a second function, and determine the second time unit based on the second function, where the second function is used to determine a channel index corresponding to first information, and the first information is used to configure at least one of the following a quantity of fragments included in the measurement signal or duration of each fragment.

For example, M1 is different from M2.

Optionally, a location of the first time unit in the n^{th} time period and/or a location of the second time unit in the (n+1)^{th} time period may be generated by using an encryption algorithm or a pseudo-random number generation algorithm.

Optionally, a length of the n^{th} time period and/or a length of the (n+1)^{th} time period are/is generated by using an encryption algorithm or a pseudo-random number generation algorithm.

Optionally, a length of the n^{th} fragment and/or a length of the (n+1)^{th} fragment are/is generated by using an encryption algorithm or a pseudo-random number generation algorithm.

Optionally, the transceiver module 1001 is further configured to receive second information, where the second information indicates the location of the first time unit in the n^{th} time period and the location of the second time unit in the (n+1)^{th} time period.

Division into the modules in embodiments of this disclosure is an example, is merely division into logical functions, and may be other division during actual implementation. In addition, functional modules in embodiments of this disclosure may be integrated into one processor, or each of the modules may exist alone physically, or two or more modules may be integrated into one module. The integrated module may be implemented in a form of hardware, or may be implemented in a form of a software functional module. It may be understood that for functions or implementations of the modules in embodiments of this disclosure, further refer to related descriptions in the method embodiments.

In a possible manner, the communication apparatus may be shown in FIG. 11. The apparatus may be a communication device or a chip in the communication device. The communication device may be the terminal device in the foregoing embodiments or the network device in the foregoing embodiments. The apparatus includes a processor 1101 and a communication interface 1102, and may further include a memory 1103. The processing module 1002 may be the processor 1101. The transceiver module 1001 may be the communication interface 1102.

The processor 1101 may be a central processing unit (CPU), a digital processing unit, or the like. The communication interface 1102 may be a transceiver, an interface circuit such as a transceiver circuit, a transceiver chip, or the like. The apparatus further includes the memory 1103 configured to store a program executed by the processor 1101. The memory 1103 may be a non-volatile memory, for example, a hard disk drive (HDD) or a solid-state drive (SSD), or may be a volatile memory, for example, a random-access memory (RAM). The memory 1103 is any other medium that can be used to carry or store expected program code in a form of an instruction or a data structure and that can be accessed by a computer, but is not limited thereto.

The processor 1101 is configured to execute the program code stored in the memory 1103, and is further configured to perform an action of the processing module 1002. Details are not described herein in this disclosure. The communication interface 1102 is further configured to perform an action of the transceiver module 1001. Details are not described herein again in this disclosure.

A connection medium between the communication interface 1102, the processor 1101, and the memory 1103 is not limited in embodiments of this disclosure. In this embodiment of this disclosure, the memory 1103, the processor 1101, and the communication interface 1102 are connected through a bus 1104 in FIG. 11. The bus is represented by a bold line in FIG. 11. A connection manner between other components is merely described as an example, and is not limited thereto. The bus may be classified into an address bus, a data bus, a control bus, and the like. For ease of representation, only one bold line is used to represent the bus in FIG. 11, but this does not mean that there is only one bus or only one type of bus.

An embodiment of the present disclosure further provides a computer-readable storage medium configured to store computer software instructions that need to be executed for execution of the foregoing processor, and the computer-readable storage medium includes a program that needs to be executed for execution of the foregoing processor.

An embodiment of this disclosure further provides a communication system, including a communication apparatus configured to implement a function of the first device in the embodiment shown in FIG. 5 and a communication apparatus configured to implement a function of the second device in the embodiment shown in FIG. 5.

A person skilled in the art should understand that embodiments of this disclosure may be provided as a method, a system, or a computer program product. Therefore, this disclosure may use a form of a hardware-only embodiment, a software-only embodiment, or an embodiment with a combination of software and hardware. In addition, this disclosure may use a form of a computer program product that is implemented on one or more computer-usable storage media (including but not limited to a disk memory, a compact disc (CD) read-only memory (ROM) (CD-ROM), an optical memory, and the like) that include computer-usable program code.

This disclosure is described with reference to the flowcharts and/or block diagrams of the method, the device (system), and the computer program product according to this disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by the computer or the processor of the other programmable data processing device generate an apparatus for implementing a specific function in one or more processes in the flowcharts and/or in one or more blocks in the block diagrams.

These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the other programmable device, to generate computer-implemented processing. Therefore, the instructions executed on the computer or the other programmable device provide steps for implementing a specific function in one or more processes in the flowcharts and/or in one or more blocks in the block diagrams.

It is clearly that a person skilled in the art can make various modifications and variations to this disclosure without departing from the spirit and scope of this disclosure. This disclosure is intended to cover these modifications and variations of this disclosure provided that they fall within the scope of the claims of this disclosure and their equivalent technologies.

What is claimed is:

1. A method comprising:
obtaining a ranging signal comprising N fragments, wherein N is an integer greater than 1;
sending an n^{th} fragment of the N fragments during a first time unit, wherein the first time unit is one of M1 time units in an n^{th} time period, wherein n is an integer greater than 0 and less than N, and wherein M1 is an integer greater than 1; and
sending an (n+1)^{th} fragment of the N fragments during a second time unit,
wherein the second time unit is one of M2 time units in an (n+1)^{th} time period,
wherein M2 is an integer greater than 1, and
wherein a time interval between the n^{th} time period and the (n+1)^{th} time period is a preset interval.

2. The method of claim 1, wherein M1 is the same as M2.

3. The method of claim 2, further comprising determining the first time unit and the second time unit based on a first linear feedback shift register (LFSR) function, wherein an initial value of the first LFSR function is related to a channel index corresponding to information, and wherein the information configures N of fragments or durations of the N fragments.

4. The method of claim 3, wherein the first LFSR function is f(x)=x⁹+x⁵+1; or a characteristic polynomial of a first sequence with a first length of M1, and wherein a highest order of the characteristic polynomial is greater than 9.

5. The method of claim 4, wherein determining the first time unit and the second time unit comprises:
initializing the first LFSR function based on the initial value;
generating N numerical values based on the first LFSR function;
separately performing a modulo operation on the N numerical values based on N to obtain a second sequence with a second length of N;
determining that the first time unit is an I^{th} time unit in the n^{th} time period, wherein I is an i^{th} element value in a third sequence, wherein i is an n^{th} element value in the second sequence, wherein the third sequence is {0, 1, 2, 3, . . . , M1−1, 0, 1, 2, 3, . . . , M1−1, . . . }, and wherein a third length of the third sequence is N; and
determining that the second time unit is a J^{th} time unit in the (n+1)^{th} time period, wherein J is a j^{th} element value in the third sequence, and wherein j is an (n+1)^{th} element value in the second sequence.

6. The method of claim 3, wherein the first LFSR function is f(x)=x¹⁵+x¹⁴+1.

7. The method of claim 6, wherein determining the first time unit and the second time unit comprises:
initializing the first LFSR function based on the initial value;
generating a first binary random sequence s_{(k+nK)} and a second binary random sequence s_{(k+(n+1) K)} based on the first LFSR function, wherein k={0, 1, 2, . . . , K−1}, and wherein K is greater than or equal to log₂ M 1;
determining that the first time unit is an hₙ^{th} time unit in the n^{th} time period, wherein hₙ=2⁰s_{nK}+2¹s_{(1+nK)}+ . . . +2^{m-1}s_{(K-1+nK)}; and
determining that the second time unit is an h₍ₙ₊₁₎^{th} time unit in the (n+1)^{th} time period,
wherein h₍ₙ₊₁₎=2⁰s_{(n+1)K}+2¹s_{(1+(n+1)K)}+ . . . +2^{m-1}s_{(K-1+(n+1)K)}.

8. The method of claim 3, wherein the initial value is W times the channel index, and wherein W is an integer greater than 0.

9. The method of claim 8, wherein a product of W and a total quantity of channels is less than or equal to a period of the first LFSR function.

10. The method of claim 2, further comprising:
obtaining the first time unit based on a second function; and
obtaining the second time unit based on the second function, wherein the second function determines a channel index corresponding to information, and wherein the information configures N fragments or durations of the N fragments.

11. The method of claim 1, wherein M1 is different from M2.

12. The method of claim 1, further comprising generating a first location of the first time unit in the n^{th} time period or a second location of the second time unit in the (n+1)^{th} time period using an encryption algorithm or a pseudo-random number generation algorithm.

13. The method of claim 1, wherein a first length of the n^{th} fragment is the same as a second length of the (n+1)^{th} fragment.

14. The method of claim 1, further comprising generating a first length of the n^{th} time period or a second length of the (n+1)^{th} time period using an encryption algorithm or a pseudo-random number generation algorithm.

15. The method of claim 1, further comprising generating a first length of the n^{th} fragment or a second length of the (n+1)^{th} fragment using an encryption algorithm or a pseudo-random number generation algorithm.

16. The method of claim 1, further comprising sending information indicating a first location of the first time unit during the n^{th} time period and a second location of the second time unit during the (n+1)^{th} time period.

17. A method comprising:
receiving, during a first time unit, an n^{th} fragment of N fragments in a ranging signal,
wherein the first time unit is one of M1 time units in an n^{th} time period, wherein n is an integer greater than 0 and less than N, and wherein M1 is an integer greater than 1; and
receiving, during a second time unit, an (n+1)^{th} fragment of the N fragments in the ranging signal, wherein the second time unit is one of M2 time units in an (n+1)^{th} time period,
wherein M2 is an integer greater than 1, and
wherein a time interval between the n^{th} time period and the (n+1)^{th} time period is a preset interval.

18. The method of claim 17, wherein M1 is the same as M2.

19. The method of claim 18, further comprising obtaining the first time unit and the second time unit based on a linear feedback shift register (LFSR) function, wherein an initial value of the LFSR function is related to a channel index corresponding to information, and wherein the information is for configuring N fragments or durations of the N fragments.

20. A communication apparatus comprising:
a memory configured to store instructions; and
a processor coupled to the memory and configured to execute the instructions to cause the communication apparatus to:
obtain a ranging signal comprising N fragments, wherein N is an integer greater than 1; and
send an n^{th} fragment of the ranging signal during a first time unit, wherein the first time unit is one of M1 time units in an n^{th} time period, wherein n is an integer greater than 0 and less than N, and wherein M1 is an integer greater than 1; and
send an (n+1)^{th} fragment of the ranging signal during a second time unit,
wherein the second time unit is one of M2 time units in an (n+1)^{th} time period,
wherein M2 is an integer greater than 1, and
wherein a time interval between the n^{th} time period and the (n+1)^{th} time period is a preset interval.
